(19) United States
(12) Patent Application Publication
(10) Pub. No.: US 2003/0169502 A1
(43) Pub. Date: Sep. 11, 2003

(54) Laser irradiation apparatus and exposure method using laser irradiation apparatus

(75) Inventor: Yukio Ogura, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/379,831

(22) Filed: Mar. 3, 2003

(30) Foreign Application Priority Data
Mar. 6, 2002 (JP) 59992/2002

(51) Int. Cl. G02B 27/10; H01S 3/00

(52) U.S. Cl. 359/618; 372/109

(57) ABSTRACT

A laser irradiation apparatus excellent in an irradiation efficiency and an irradiation quality, and an exposure method using the laser irradiation apparatus are provided, the apparatus comprising an optical unit including a semiconductor laser array in which a plurality of semiconductor lasers emitting laser beams are disposed, light propagation means for propagating the laser beams to deliver a propagated laser beam, and an optical device including a mask, on which irradiation patterns for irradiating the propagated laser beam are formed, and an image forming optical element for forming an image of the propagated laser beam irradiated from the irradiation patterns of the mask. The apparatus enables simultaneous scanning of a plurality of laser beams with uniform light intensity distribution.

### BACKGROUND OF THE INVENTION

The present invention relates to a laser irradiation apparatus and an exposure method using the laser irradiation apparatus.

In process of manufacturing a display board using liquid crystal materials, organic EL element materials and the like, mask exposure process is necessary. Such mask exposure has been conventionally performed by irradiating laser beams on a mask, which has a size of approximately the same size as the display board. For example, in a liquid crystal display board such as a color TFT (Thin Film Transistor) liquid crystal display and the like, a color filter is one of the constituent components thereof, which includes a black matrix and a color film, the mask exposure has been applied in manufacturing steps of forming a black matrix and a color film.

Generally, in the foregoing mask, a plurality of irradiation patterns of apertures are formed corresponding to the entire irradiation surface of the display board. The mask exposure technology enables simultaneous irradiation of laser beams onto all of predetermined exposure positions on an irradiation surface of an object to be irradiated. Thus, the mask exposure technology generally has advantages of a short operation time and good productivity. Moreover, by use of the mask exposure technology, the irradiated object such as the display board can be irradiated with laser beams of a uniform light intensity distribution.

Incidentally, respective manufacturers of the foregoing display board and the like have carried out fundamental research and development for achieving a large-sized display board and for improving a color definition at the same time and carried out research and development in regards to production technologies necessary for commercialization thereof. For example, to produce a large-sized display board by use of conventional mask exposure, it is necessary to produce a large-sized mask and to perform exposure by using a large-sized laser irradiation device. Moreover, to improve a color definition of an image projected on the display board, it is necessary to miniaturize respective patterns of R (red), G (green) and B (blue) color films of color filters in a liquid crystal display board and to narrow pitches of the respective patterns. Accordingly, with regard to irradiation patterns in a mask, it is necessary to miniaturize the irradiation patterns to narrow their pitches.

However, it is generally difficult in technic to form with good precision miniaturized irradiation patterns with narrowed pitches on a large-sized mask. Therefore, to produce a large-sized display board having narrowed pitches, it has been expected a new exposure technology.

As an exposure technology, assumed is a deflection-scanning technology using a polygon mirror, a galvanometer mirror and the like, which is applied in a laser printer, for example. However, this technology has a drawback in that a structure size of an optical system increases in size as a display board size becomes large and a scanning range is widened. Moreover, the deflection-scanning technology has a difficulty in performing simultaneous scanning of a plurality of laser beams because of the large optical system size. Thus, the deflection-scanning technology is disadvantageous in productivity in comparison with the foregoing mask exposure. Furthermore the deflection-scanning technology has a drawback in that irradiation of laser beams for a predetermined exposure position cannot be performed with good precision since an image forming lens such as a fθ lens is used and shapes of the laser beams differ in between the vicinity of an optical axis (center portion) and in a peripheral portion of scanning. Accordingly, the deflection-scanning technology can not overcome the foregoing problems.

As another exposure technology, also assumed is a technology applied for a laser processing apparatus such as a laser welding. The laser processing apparatus used in this technology uses a CO₂ laser and a Nd:YAG laser having high power as a light source and converges a laser beam by usage of optical elements while guiding the laser beam through an optical fiber. Further, this technology has a difficulty in performing simultaneous scanning of a plurality of laser beams because of large sized components constituting the light source and the optical elements. Thus, the technology has a drawback in that productivity thereof is low in comparison with the foregoing mask exposure. Accordingly, the technology used for the foregoing laser processing apparatus is not suitable to resolve the foregoing problems.

Furthermore, according to the above-described technologies, a light intensity of the beam spot comes to have Gaussian distribution, in which a central portion of the beam is the most intense in a light intensity distribution, due to characteristics of optical elements thereof. Thus, according to the technologies, there is a drawback that laser beam irradiation having a uniform light intensity distribution cannot be performed.

As described above, in place of the mask exposure technology, the above mentioned technologies are assumed. However, contrary to the foregoing mask exposure, these technologies cannot perform simultaneous irradiation of the laser beams on the entire irradiation surface of an object to be irradiated. Thus, productivity of these technologies is low, and adoption thereof is impossible in an actual production process.

Consequently, it has been expected to develop a laser irradiation device capable of simultaneously scanning of a plurality of laser beams and miniaturizing optical elements including a light source. Moreover, from the viewpoint of improving an irradiation quality of laser beams, laser irradiation apparatus capable of delivering laser beams having a uniform light intensity distribution is expected.

### SUMMARY OF THE INVENTION

Therefore, it is an object of the present invention to provide a laser irradiation apparatus capable of performing excellent irradiation efficiency and irradiation quality.

It is another object of the present invention to provide a laser irradiation apparatus capable of simultaneously scanning of a plurality of laser beams having uniform laser intensity distribution.

It is further an object of the present invention to provide an exposure method capable of performing excellent irradiation efficiency, and irradiation quality.

To achieve the foregoing object, the laser irradiation apparatus of the present invention comprises an optical unit, wherein the optical unit includes; a semiconductor laser array in which a plurality of semiconductor lasers emitting laser beams are disposed; light propagation means for propagating the laser beams to deliver a propagated laser beam; and an optical device including a mask, on which an irradiation pattern for irradiating the propagated laser beam is formed, and an image forming optical element for forming an image of the propagated laser beam irradiated from the irradiation pattern. The laser irradiation apparatus enables simultaneous scanning of a plurality of laser beams with uniform light intensity distribution.

An exposure method using the laser irradiation apparatus enables to simultaneously scan a plurality of laser beams having uniform light intensity distribution.

### BRIEF DESCRIPTION OF THE DRAWINGS

FIG. 1 shows a schematic perspective view of an entire structure of a laser irradiation apparatus according to a first embodiment of the present invention;

FIG. 2 shows a perspective view of an optical unit in the laser irradiation apparatus shown in FIG. 1;

FIG. 3 shows a side view of one part of an optical device shown in FIG. 2;

FIG. 4 shows a front view of a mask contained in the optical device shown in FIG. 3;

FIG. 5 shows a schematic front view of an object to be irradiated, for explaining an irradiation operation of the laser irradiation apparatus according to the present invention;

FIG. 6 shows a side view of an optical device according to a second embodiment of the present invention; and

FIG. 7 shows a front view of a mask contained in the optical device shown in FIG. 6.

### DETAILED DESCRIPTION OF THE PREFERRED EMBODIMENT

Next, preferred embodiments of a laser irradiation apparatus of the present invention will be described with reference to the drawings.

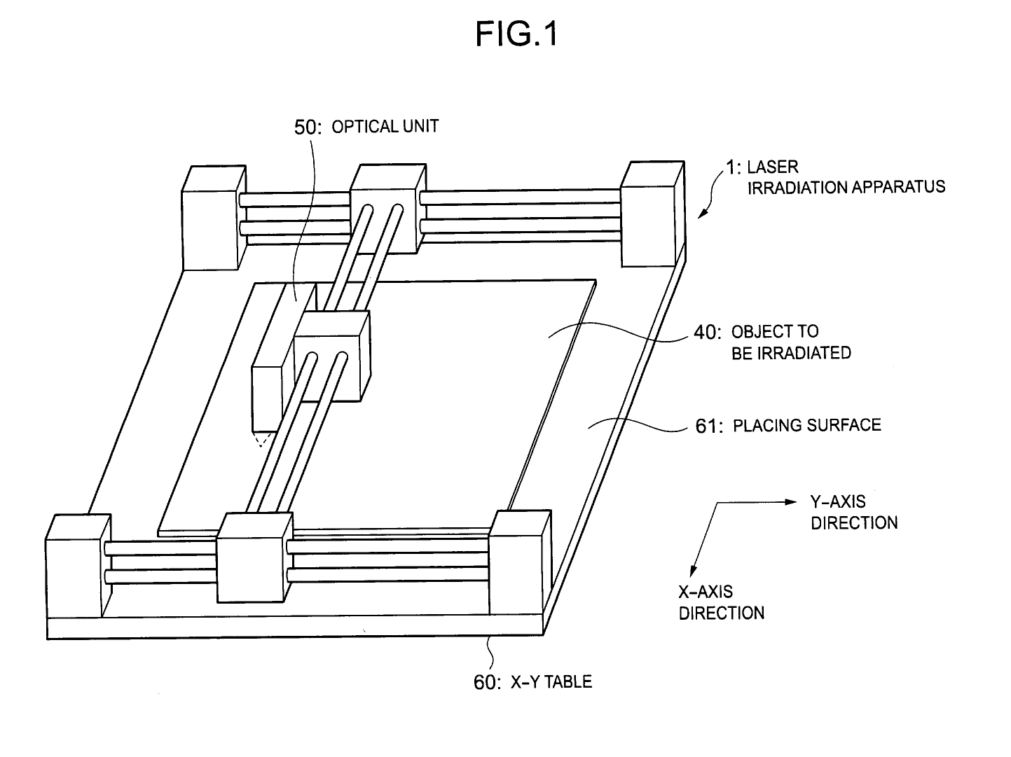

In FIG. 1 showing the first embodiment according to the present invention, the laser irradiation apparatus 1 comprises an optical unit 50 for irradiating a plurality of laser beams, and an X-Y table 60 in which the optical unit 50 is freely moved in the X-axis and Y-axis directions. On a placing surface 61 of the X-Y table 60, an object 40 having a rectangular plate shape is placed and is fixed to be irradiated while being fixed by a vacuum chuck action, for example. The optical unit 50 and/or the X-Y table 60 are moved and fixed according to turning on/off of laser irradiation operation of the optical unit 50.

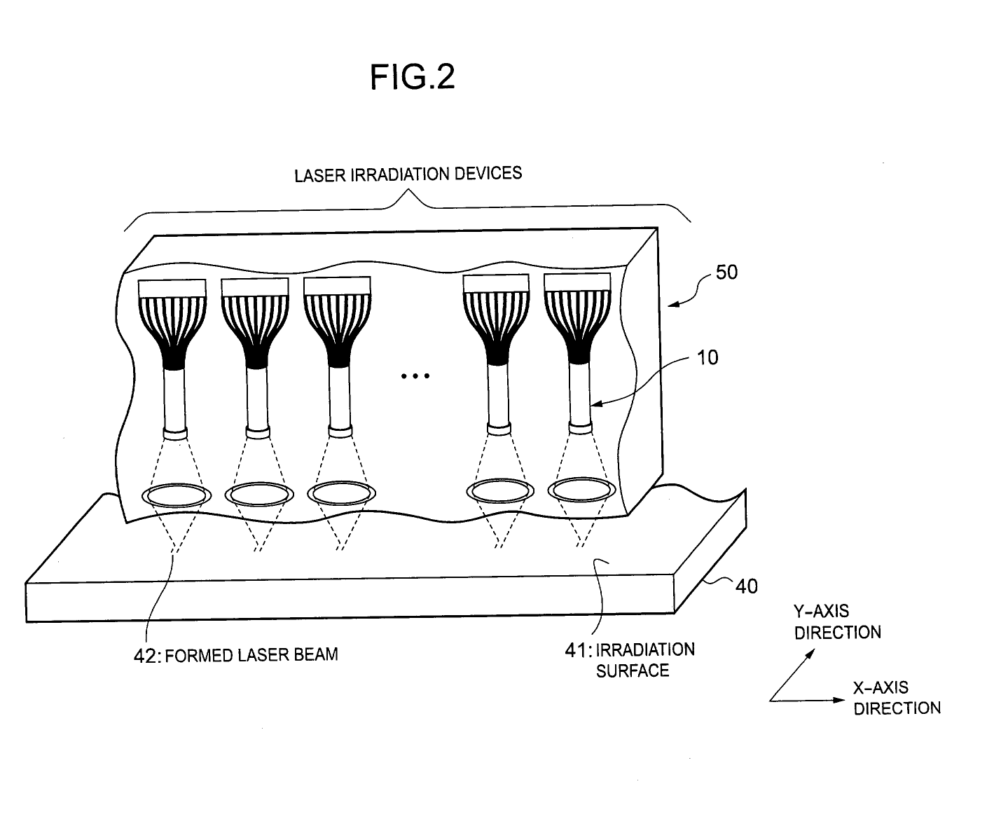

As shown in FIG. 2, the optical unit 50 has a constitution in which n(integer) pieces of optical devices 10 are aligned in the X-axis direction. With such constitution, a plurality of the optical devices 10 simultaneously irradiate a plurality of laser beams, thus enabling remarkably improve an irradiation efficiency, thereby remarkably improving productivity.

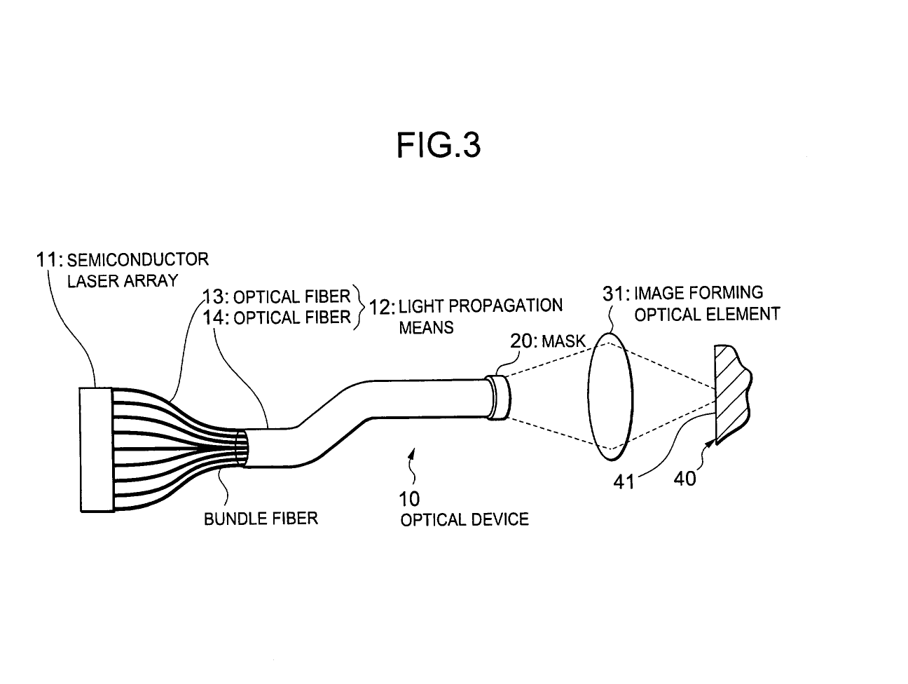

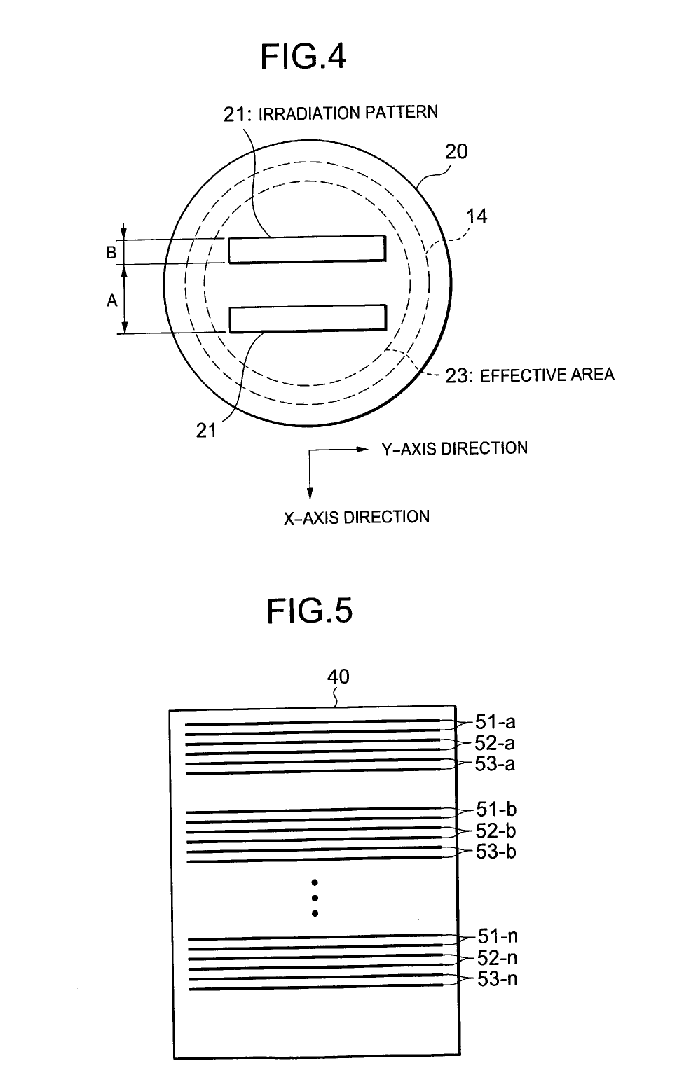

Next, the optical device 10 constituting the optical unit 50 will be described with reference to FIG. 3. In this Figure, the optical device 10 includes a semiconductor laser array 11, in which a plurality of semiconductor lasers are disposed, light propagation means 12 for propagating the laser beams, a mask 20, in which irradiation patterns 21 (shown in FIG. 4) for irradiating the laser beams are provided, and an image forming optical element 31 for forming an image of the laser beams irradiated from the irradiation patterns 21. In this embodiment, the type of the semiconductor laser is not particularly limited and, for example, a semiconductor laser of a gallium arsenic base, an indium phosphide base or the like can be applied. These semiconductor lasers have an approximately square-shaped emission point having a side of about 100 μm. The semiconductor lasers are disposed by being arranged approximately linearly with intervals of about 200 μm to 300 μm therebetween.

In the arrangement of the semiconductor lasers, the number of the semiconductor lasers disposed is determined according to an output power of each of the semiconductor lasers. For example, the use of a semiconductor laser with a large output power reduces the number thereof, and on the other hand, the use of a semiconductor laser with a small output power necessitates a large number of semiconductor lasers to be disposed. Moreover, the shape and size of the emission point of the semiconductor laser and the position where the semiconductor lasers are disposed and the interval therebetween are not limited to those in the foregoing structure. For example, the emission point of the semiconductor laser may have an approximately circle shape, and the semiconductor lasers may be disposed in a lattice manner.

The light propagation means 12 has a structure, in which a plurality of optical fibers 13 and a single optical fiber 14 are connected to each other. The respective optical fibers 13 are provided corresponding to the emission points of the respective semiconductor lasers one on one. Specifically, one end of each of the optical fibers 13 is provided to be close to the emission point of each of the semiconductor lasers, and the other end thereof exists as a bundle fiber bundling all of the optical fibers 13. The single optical fiber 14 is connected to the optical fibers 13 so as to be in contact with an end surface of the bundle fiber. Herein, a plurality of laser beams irradiated from each of the optical fibers 13 are combined within the single optical fiber 14 and thus are irradiated as a laser beam having a uniform intensity distribution from an irradiation port of the single optical fiber 14. At the irradiation port of the single optical fiber 14, the mask 20 is provided. An image of the irradiation pattern 21 formed on the mask 20 is imaged on an irradiation surface 41 of the irradiated object 40 by an image forming lens 31 as the image forming optical element. In this embodiment, the mask 20 corresponds to the laser beam emitted from one semiconductor laser array 11. The corresponding size of the mask 20 is reliably practical for manufacturing. Therefore, according to the present invention, the size of a mask is not required to become large even though the irradiated object 40 becomes large. An effective area 23 of the mask is the same in size as or smaller than an end face of the irradiation port of the single optical fiber 14. Within the effective area 23, rectangular irradiation patterns 21 are formed in two spots.

According to the first embodiment, the laser irradiation apparatus 1 is constituted, in which the mask 20 has long and thin irradiation patterns 21 and in which the optical unit 50 is moved in the longitudinal direction (Y-axis direction) of the irradiation patterns 21. With such constitution, the longer the irradiation patterns 21 are in the longitudinal direction, the more the laser is irradiated. Thus, the optical unit 50 can be shifted at high speed and productivity is further improved.

According to the present invention, the long and thin shape of the irradiation pattern is not limited to the foregoing rectangular shape. For example, the irradiation pattern may have any shapes such as a long and thin oblong shape, a parallelogram and the like. Moreover, to further improve the irradiation efficiency, a number of irradiation patterns 21 in the mask 20 may be desirably increased.

Next, the operation of the laser irradiation apparatus 1 will be described hereinafter. As shown in FIG. 1, the object to be irradiated 40 is placed and fixed onto the placing surface. The optical unit 50 is shifted so as to focus a plurality of laser beams delivered from the optical unit 50 at a predetermined exposure position on the object 40. After this, the optical unit 50 is moved in the Y-axis direction and simultaneously scans the plurality of laser beams onto the object 40.

When the optical unit 50 reaches an end position of the Y-axis direction, the irradiation of the laser beams is inhibited and then the optical unit 50 is shifted by just a necessary distance in the X-axis direction. Then, the optical unit 50 irradiates a plurality of laser beams again and is moved in the reverse direction of the Y-axis for scanning. In this embodiment, for scanning, the optical unit 50 is moved back and forth in the Y-axis direction. Alternatively, it is of course possible that the optical unit 50 is moved in a constant direction of the Y-axis direction while scanning. In this case, the optical unit 50 is shifted back to the initial position in the Y-axis direction without scanning after the optical unit 50 reaches the end position of the Y-axis direction. In shifting the optical unit 50 in the X-axis direction, a shifting amount of the optical unit 50 in the X-axis direction corresponds to an amount twice the pitch “A” in case where the irradiation pattern 21 formed on the mask 20, which is composed of two rectangles with openings as shown in FIG. 4 and the laser irradiation apparatus 1 performs exposure at equal intervals on the entire surface of the object to be irradiated. In other words, in a first scanning, as shown in FIG. 5, the laser beams are irradiated onto regions of 51-a, 51-b, . . . , 51-n. After the optical unit 50 is shifted by the distance twice the irradiation pitch “A” in the X-axis direction, the laser beams are irradiated onto regions of 52-a, 52-b, . . . , 52-n while scanning in the Y-axis direction. Similarly, when the optical unit 50 is shifted by the distance twice the irradiation pitch “A” in the X-axis direction and then moved in the Y-axis direction for scanning, the laser beams can be irradiated onto regions of 53-a, 53-b, . . . , 53-n. Consequently, by sequentially shifting the optical unit 50, the laser beams are irradiated at equal intervals on the entire irradiation surface 41 of the irradiated object 40.

As described above, in the laser irradiation apparatus 1 of this embodiment, miniaturization and weight saving of the optical unit 10 is realized by use of the semiconductor lasers as the light source. Thus, it is easy to shift-and-move the optical unit 50 really and the plurality of laser beams can be scanned, thereby significantly improving productivity. Moreover, the single optical fiber 14 can combine the laser beams emitted from the plurality of semiconductor lasers and the combined laser beam is irradiated through the irradiation pattern 21 of the mask 20. Thus, even when the laser beam is irradiated onto any given spot, the laser irradiation apparatus 1 of the invention can perform the laser beam irradiation having a uniform light intensity distribution.

Further, according to the invention, it is possible to arrange a plurality of optical units 50 in two-dimension with respect the X-Y table. With such constitution, more laser beams can be simultaneously irradiated thereby further improving productivity. Moreover, if all optical units 50 required in X-axis direction are disposed, the laser beams are irradiated onto the entire irradiation surface 41 of the irradiated object 40 by just moving the optical units 50 once in the Y-axis direction and thus an in-line production manner can be executed.

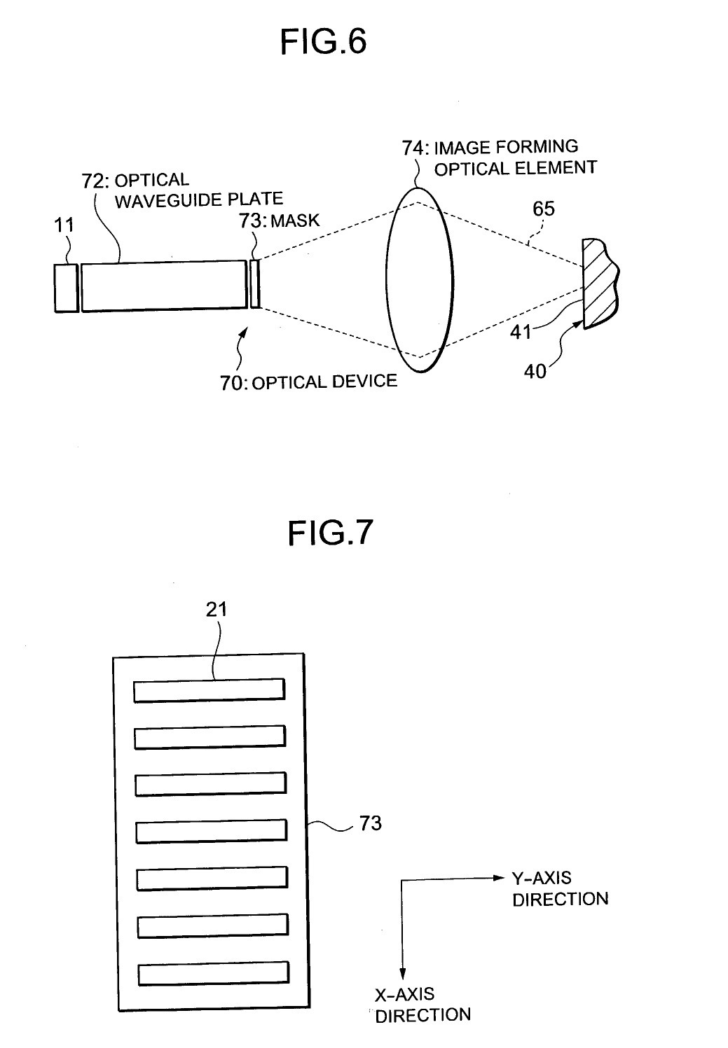

With reference to FIG. 6 showing an optical device 70 according to a second embodiment of the invention, a semiconductor laser array 11, in which a plurality of semiconductor lasers are disposed, an optical waveguide plate 72 as light propagation means for propagating the laser beams, a mask 73, in which irradiation patterns for irradiating the laser beams are formed, and an image forming optical element 74 for forming an image of the laser beams irradiated from the irradiation patterns. In the second embodiment, the other parts except to the optical device 70 are the same as those of the foregoing first embodiment. The laser beams emitted from the respective semiconductor lasers of the semiconductor laser array 11 are made incident on the optical waveguide plate 72. Herein, the optical waveguide plate 72 as the light propagation means is made of a rectangular glass plate. When the laser beams emitted from the semiconductor laser array 11 are made incident in the optical waveguide plate 72, the laser beams are repeatedly reflected numerous times within the optical waveguide plate 72. Thus, the laser beam irradiated from an outlet port of the optical waveguide plate 72 becomes a laser beam having a uniform light intensity distribution. At the outlet port of the optical waveguide plate 72, the mask 73 is provided. In the mask 73, as shown in FIG. 7, a plurality of rectangular irradiation patterns 21 are formed in multiple spots. From this irradiation pattern 21, the laser beam with the uniform light intensity distribution is irradiated by the optical waveguide plate 72 through the mask 73.

According to the second embodiment, by use of the optical waveguide plate 72 as the light propagation means, the light beams from a plurality of light sources are reflected numerous times and combined in the optical waveguide plate 72. Thus, the laser beam having the uniform light intensity distribution can be irradiated from the irradiation pattern 21 of the mask 73.

The respective embodiments of the present invention have been described above. However, the present invention is not limited to the above-described embodiments and various modified embodiments are possible within the scope of the present invention. For example, thermal processing, welding, drilling, cutting and the like for micro-processing are efficiently performed.

In the above mentioned embodiments, only the optical unit 50 is controlled for shifting and moving. However, it is possible to move-control both the optical unit 50 and the X-Y table 60. Further, it is also possible to move-control the X-Y table while fixing the optical unit 50. In addition, the optical unit 50 may have rotating mechanism to adjust an angle position thereof in a peripheral direction.

The above mentioned embodiments are also effective as an exposure method. The exposure method according to the invention comprises steps in which, first the optical device combines laser beams emitted from a plurality of semiconductor lasers disposed in a semiconductor laser array by use of an optical fiber, an optical waveguide plate or the like, for example, thereby producing a laser beam having a uniform light intensity distribution. Next, the optical unit irradiates the combined laser beam from the irradiation pattern of the mask at the predetermined exposure position of the object to be irradiated. Moreover, as described above, by using the mask having a plurality of irradiation patterns and by moving the optical unit including a plurality of optical devices, simultaneous irradiation of the plurality of laser beams can be performed.

As described above, according to the exposure method of the present invention, since the optical unit delivering a plurality of laser beams can be miniaturized, it becomes possible to simultaneously scan a plurality of laser beams at the predetermined position of the and thus productivity is improved.

Moreover the above mentioned embodiments are further effective as a method for manufacturing a color filter. Note that, as the color filter, generally, a stripe arrangement, a mosaic arrangement, a delta arrangement and the like are used. For a high-definition color filter that is made in a large size, the stripe arrangement is used. Moreover, in the manufacturing process of the color filter, exposure is performed in fabricating a black matrix and in forming R, G and B color films. In the color filter manufacturing method according to the invention, first, the optical device combines laser beams emitted from a plurality of semiconductor lasers disposed in the semiconductor laser array by use of the optical fiber, the optical waveguide plate or the like, thereby producing the laser beam having a uniform light intensity distribution. Next, the optical unit irradiates the combined laser beam delivered from the irradiation pattern of the mask at a predetermined exposure position of the object to be irradiated. Further, by shifting the optical unit relatively with a color filter substrate, the plurality of laser beams are scanned at a predetermined exposure position of the color filter substrate. According to the color filter manufacturing method according to the invention, a large-sized color filter can be produced efficiently though a large-sized color filter has not been manufactured by the conventional technique.

As described above, according to the laser irradiation apparatus of the present invention, without performing a conventional mask exposure using a large size mask, the laser beams emitted from the semiconductor laser array can be efficiently scanned on the irradiation surface of the irradiated object. Moreover, the irradiated laser beam has the uniform light intensity distribution and thus irradiation of the laser beam having excellent irradiation quality is perfromed.

What is claimed is:

1. A laser irradiation apparatus, comprising an optical unit, wherein the optical unit includes;
a semiconductor laser array in which a plurality of semiconductor lasers emitting laser beams are disposed;
light propagation means for propagating the laser beams to combine the laser beams from the semiconductor laser array to deliver a propagated laser beam; and
an optical device including a mask, on which an irradiation pattern for irradiating the propagated laser beam is formed, and an image forming optical element for forming an image of the propagated laser beam irradiated from the irradiation pattern.

2. A laser irradiation apparatus according to claim 1, further comprising a X-Y table, above which the optical unit is arranged.

3. A laser irradiation apparatus according to claim 1, wherein the light propagation means includes a bundle fiber for bundling a plurality of optical fibers propagating the laser beams emitted from the plurality of semiconductor lasers and a single optical fiber connected to a tip of the bundle fiber.

4. A laser irradiation apparatus according to claim 1, wherein the light propagation means includes an optical waveguide plate propagating the laser beams emitted from the plurality of semiconductor lasers.

5. A laser irradiation apparatus according to claim 1, wherein a plurality of the irradiation patterns are formed on the mask.

6. A laser irradiation apparatus according to claim 1, wherein the mask has a plurality of irradiation patterns formed to be long and thin.

7. An exposure method using a laser irradiation apparatus which comprises an optical unit including a semiconductor laser array in which a plurality of semiconductor lasers emitting laser beams are disposed, light propagation means for propagating the laser beams to deliver a propagated laser beam, and an optical device including a mask, on which irradiation patterns for irradiating the propagated laser beam are formed, the method comprising a step of
scanning patterned laser beams formed by the mask, the patterned laser beams being delivered from the light propagation means through the mask.
